(19) United States
(12) Patent Application Publication
(10) Pub. No.: US 2005/0121209 A1
(43) Pub. Date: Jun. 9, 2005

(54) Transportable power tool

(75) Inventors: Hidenori Shimizu, Hikone-shi (JP); Toshiharu Ohashi, Sakata-gun (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 10/984,971

(22) Filed: Nov. 10, 2004

(30) Foreign Application Priority Data
Nov. 11, 2003 (JP) 2003-381458

(51) Int. Cl. B27C 3/08

(52) U.S. Cl. 173/217; 173/170

(57) ABSTRACT

A transportable power tool such as an impact driver has a power unit in which a motor and a reducer-transmitter are contained, a grip and a coupler unit with which a battery pack is coupled. Maximum dimensions of the power unit and maximum dimensions of the battery pack in a direction perpendicular to both of center axes of the power unit and the grip and in a direction parallel to the center axis of the power unit are larger than those of the grip in the same directions. Operation members used for selecting an operation mode of the motor and a display device are provided at positions near to the grip from a line binding contacting portions of the power unit and the battery pack when the power unit and the battery pack are simultaneously contacted with the same plane in each state.

### BACKGROUND OF THE INVENTION

1. Field of the Invention

The present invention relates to a transportable (or handheld) power tool used for fastening a bolt, a nut, a screwnail, and so on, for drilling metalwork, woodwork, mortar, concrete, and so on, or for cutting metalwork, woodwork, and so on.

2. Description of the Related Art

A conventional transportable power tool is described with reference to FIGS. 9A and 9B. FIG. 9A is a side view of the conventional transportable power tool. As can be seen from FIG. 9A, in the conventional transportable power tool, a cylindrical shaped power unit 8 is provided at a top end of a grip 7 in a manner so that a center axis of the cylindrical shape of the power unit 8 crosses a center axis of the grip 7 at a predetermined angle near to right angle. A battery pack 6 is detachable provided at a bottom end of the grip 7. Generally, a diameter of the cylindrical shape of the power unit 8 is larger than a width of the grip 7 in a direction perpendicular to a paper sheet of FIG. 9A. The width of the battery pack 6 is similarly wider than that of the grip 7.

FIG. 9B is a plan view showing a part in the vicinity of a rear end the power unit 8. A circular knob 11′ of an operation switch is rotatably provided on an outer face in the vicinity of the rear end of the power unit 8, by which an operation mode (for example, a torque mode) of the power tool is selected among a plurality of the operation modes. Alternatively, in another conventional transportable power tool, a ring shaped finger grip (not shown) is rotatably provided around the center axis of the cylindrical shape of the power unit 8 on a front or rear end of the cylindrical shaped power unit 8.

The conventional transportable power tool, however, has a possibility that the power tool is fallen from a hand of a user or toppled down due to careless handling. Because of the above-mentioned feature with respect to the shape of the power tool that the dimensions of the power unit 8 and the battery pack 6 are partially larger than those of the grip 7, when the power tool is fallen or toppled down, a part of the cylindrical outer faces above the center axis of the cylindrical shape or the rear face of the power unit 8, or a part of the side faces or the bottom face of the battery pack 6 could be bumped against the land surface or the floor face. Since the knob 11′ or the finger grip of the operation switch is provided on the outer face of the power unit 8, the knob 11′ or the finger grip could be damaged due to the falling or toppling of the power tool.

On the other hand, still another conventional transportable power tool, for example, shown in laid open publication of Japanese patent application 7-161340 has a display device on the battery pack for indicating the capacity of the battery. A width of a rear end of the battery pack is narrowed, and the display device is provided on the narrowed rear end. Thus, the display device may not be damaged when the power tool is fallen or toppled down in sidewise. The display device, however, will be damaged, if the power tool is fallen or toppled down backend-to.

### SUMMARY OF THE INVENTION

A purpose of the present invention is to provide a transportable power tool in which an operation member used for switching the operation mode may not be damaged due to bumping against the land surface or the floor face, even when the power tool is fallen or toppled down.

A transportable power tool in accordance with an aspect of the present invention comprises: a motor; a reducer-transmitter for reducing rotation speed of a driving shaft of the motor and for transmitting a driving force of the motor to an output shaft thereof; a control circuit for controlling driving of the motor; a housing for enclosing the motor, the reducer-transmitter and the control circuit; and a battery pack detachably coupled with the housing.

The power tool has a power unit in which at least the motor and the reducer-transmitter are contained, a grip and a coupler unit formed at an end of the grip opposite to the power unit with which battery pack is coupled. A center axis of the output shaft crosses a center axis of the grip around which a perm and fingers of a user grip at a predetermined angle near to right angle.

Maximum dimensions of the power unit and maximum dimensions of the battery pack in a direction perpendicular to both of the center axis of the output shaft and the center axis of the grip and in a direction parallel to the center axis of the output shaft are larger than those of the grip in the same directions.

At least an operation member used for selecting an operation mode of the motor is provided at a position near to the grip from a line binding contacting portions of the power unit and the battery pack when the power unit and the battery pack are simultaneously contacted with the same plane in each state.

By such a configuration, the operation member may not be damaged due to bumping against the land surface or the floor face even when the power tool is fallen or toppled down on the land surface or the floor face. Consequently, the transportable power tool can be used stably over the long term. Furthermore, it is no need to reinforce the mechanical strength of the operation member and so on, so as not to be damaged due to the bumping. Thus, it is possible to reduce the cost of the transportable power tool.

### BRIEF DESCRIPTION OF THE DRAWINGS

FIG. 1 is a perspective view showing an appearance and a configuration of a transportable power tool in accordance with an embodiment of the present invention;

FIG. 2 is a schematic sectional view showing an arrangement of elements of the transportable power tool in the embodiment;

FIG. 3 is a partial sectional view showing a detailed configuration of a main portion of the transportable power tool in the embodiment;

FIG. 4 is a block diagram showing a circuit configuration of the transportable power tool in the embodiment;

FIG. 5 is a side view showing an example of toppling down of the transportable power tool;

FIG. 6 is a side view showing another example of toppling down of the transportable power tool;

FIG. 7 is a front view showing still another example of toppling down of the transportable power tool;

FIG. 8 is a perspective view showing an appearance and a configuration of a modified transportable power tool in accordance with an embodiment of the present invention;

FIG. 9A is a side view showing an appearance and a configuration of a conventional transportable power tool; and

FIG. 9B is a partial plan view of the conventional transportable power tool.

### DETAILED DESCRIPTION OF THE EMBODIMENT

A transportable power tool in accordance with an embodiment of the present invention is described with reference to drawings.

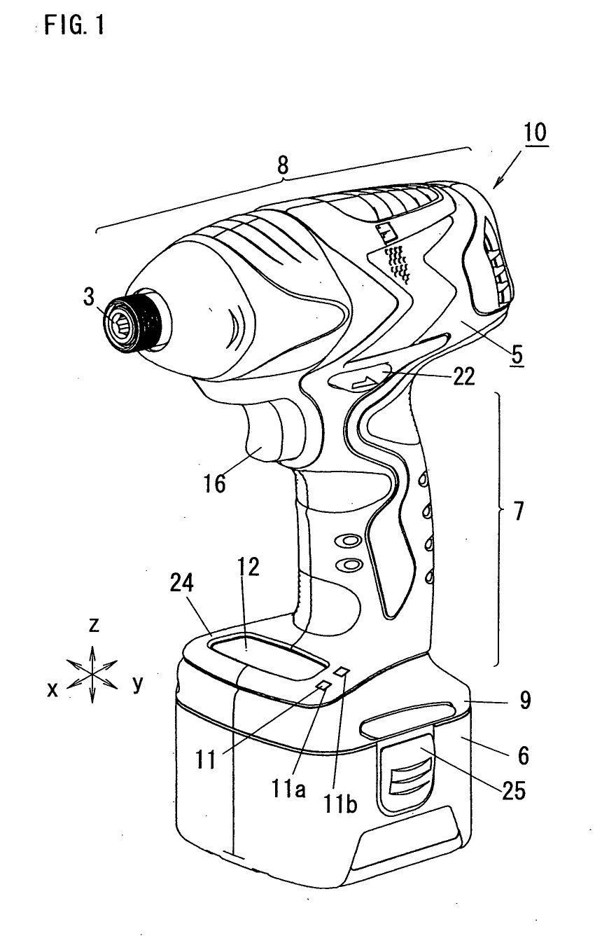

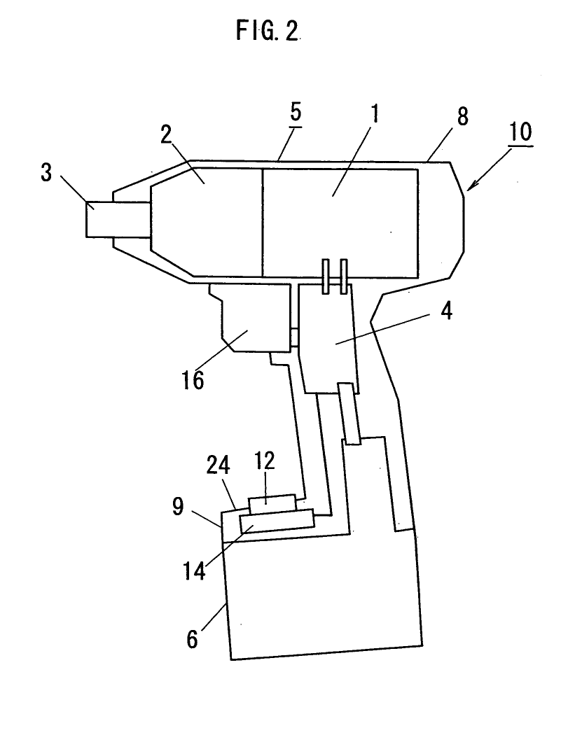

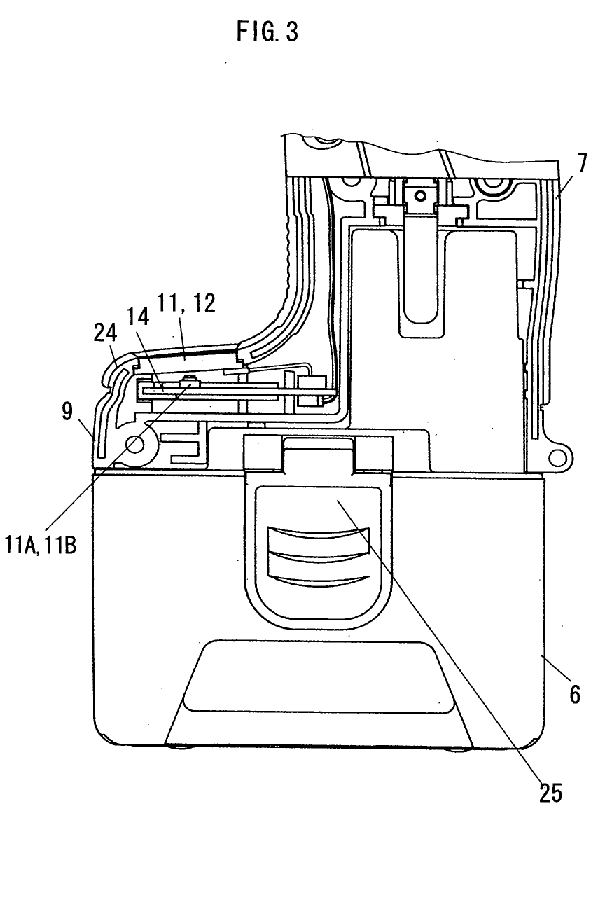

An appearance and a configuration of a transportable power tool (hereinafter, abbreviated as “power tool”) 10 in accordance with the embodiment are shown in FIG. 1. The transportable power tool 10 is, for example, an impact power tool, a power drill/driver, or the like. A block configuration of the power tool 10 is shown in FIG. 2. A detailed configuration of a main portion of the power tool 10 in the embodiment is shown in FIG. 3.

The power tool 10 comprises a motor 1, a reducer-transmitter 2 for reducing rotation speed of a driving shaft of the motor 1 and for transmitting a driving force of the motor 1 to an output shaft 3 of the reducer/transmitter 2, a switching circuit 4, a trigger lever 16 for switching on and off of the driving of the motor 1, a rotation switch lever 22 for switching the rotation direction of the motor 1 between normal and reverse directions, a control circuit 14 for controlling driving of the motor 1, operation members 11 (11a and 11b) used for selecting an operation mode of the motor 1, a display device 12, a housing 5 for enclosing the above-mentioned components and a battery pack 6 detachably coupled with the housing 5. The operation members 11 are, for example, buttons made of resin molding, which are movably held on the housing 5.

The power tool 10 has a power unit 8 and a grip 7. The motor 1 and the reducer-transmitter 2 including the output shaft 3 are contained in a portion of the housing 5 corresponding to the power unit 8. A center axis of the output shaft 3 crosses a center axis of the grip 7 around which a perm and fingers of a user grip at a predetermined angle near to right angle. The predetermined angle, however, is not necessarily right angle. The power tool 10 further has a coupler unit 9 having a coupler structure with which battery pack 6 is coupled at a lower end of the grip 7 opposite to the power unit 8. A pair of detaching operation members 25 is provided on sidewalls of the battery pack 6. When the user pushes the detaching operation members 25, the battery pack 6 can be detached from the coupler unit 9. When the battery pack6 is forcibly pushed toward the coupler unit 9, the battery pack 6 is coupled with the coupler unit 9.

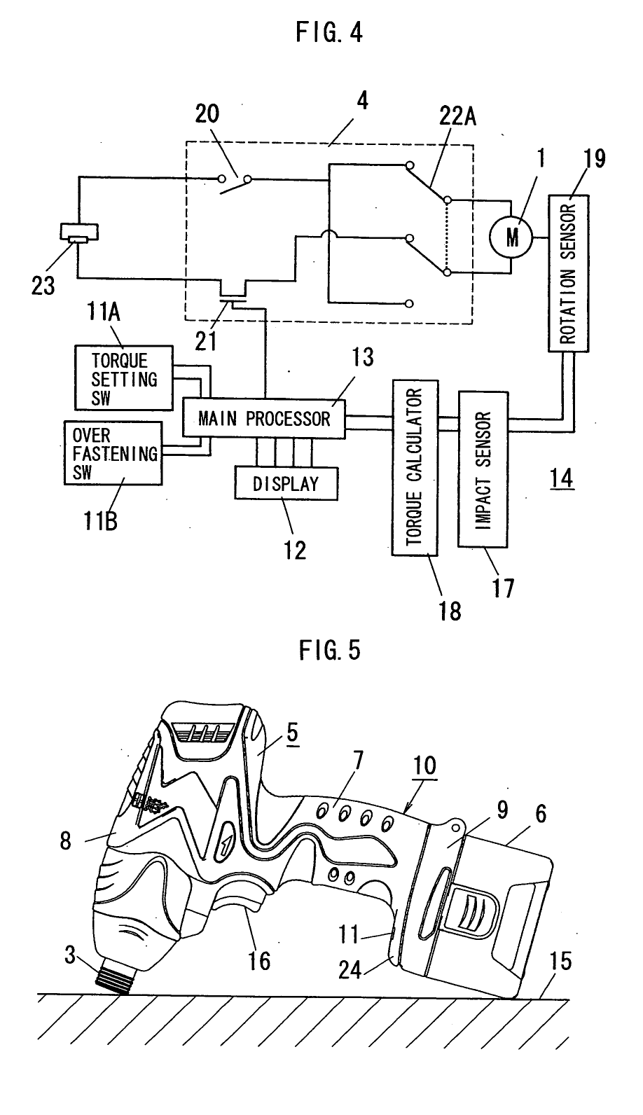

The portion of the housing 5 corresponding to the power unit 8 has, for example, a substantially cylindrical shape. Cross-section of the power unit 8 in a direction perpendicular to the center axis of the output shaft 3 is circular, elliptic, round triangular, or the like. The motor 1 and the reducer-transmitter 2 are provided in the power unit 8. A switching circuit 4 is provided in the grip 7. A trigger lever 16 is slidably provided at a neck portion between the power unit 8 and the grip 7 in a manner so that a rear end portion of the trigger lever 16 can be moved in and out with respect to the inside of the grip 7. Similarly, the rotation switch lever 22 is movably provided at the neck portion between the power unit 8 and the grip 7 in a manner so that a normal/reverse rotation switch 22A (see FIG. 4) is switched for varying a direction of a current flowing in windings of the motor 1 is reversed corresponding to the position of the rotation switch lever 22. The operation members 11, the display device 12 and the control circuit 14 are provided in a portion of the housing 5 corresponding to the coupler unit 9, as shown in FIG. 3.

Hereupon, a direction parallel to the center axis of the output shaft 3 is defined X-direction, as shown in FIG. 1. A direction perpendicular to both of the center axis of the output shaft 3 and a line binding the power unit 8 and the battery pack 6 which is substantially parallel to the center axis of the grip 7 is defined Y-direction. A direction perpendicular to both of the center axis of the output shaft 3 and the center axis of the grip 7 is defined Z-direction. Furthermore, in X-direction, a part of the output shaft 3 is called “front”, and the opposite part is called “rear”. In Z-direction, a part of the power unit 8 is called “upper”, and a part of the battery pack 6 is called “bottom”.

A maximum dimension (length) of the power unit 8 in X-direction is larger (longer) than that of the grip 7, and a maximum dimension (width) of the power unit 8 in Y-direction is larger (wider) than that of the grip 7. In other words, the profile of the grip 7 in X-direction and Y-direction is smaller than the profile of the power unit 8 in the same directions, and the profile of the grip 7 is positioned inside the profile of the power unit 8, when the power tool 10 is projected on X-Y plane.

Maximum dimensions (length and width) of the coupler unit 9 provided on the lower end of the grip 7 in X-direction and Y-direction are larger (longer and wider) than those of the grip 7 in the same directions. The profile of the grip 7 in X-direction and Y-direction is smaller than the profile of the coupler unit 9 in the same directions, and the profile of the grip 7 is positioned inside the profile of the coupler unit 9, when the power tool 10 is projected on X-Y plane.

Maximum dimensions (length and width) of the battery pack 6 in X-direction and Y-direction are substantially the same as those of the coupler unit 9 in the same directions. Thus, the maximum dimensions (length and width) of the battery pack 6 in X-direction and Y-direction are larger (longer and wider) than those of the grip 7 in the same directions. The profile of the grip 7 in X-direction and Y-direction is smaller than the profile of the battery pack 6 in the same directions, and the profile of the grip 7 is positioned inside the profile of the battery pack 6, when the power tool 10 is projected on X-Y plane.

In this embodiment, the operation members 11 and the display device 12 are provided at positions near to the grip 7 from a line binding contacting portions of the power unit 8 and the battery pack 6 when the power unit 8 and the battery pack 6 are simultaneously contacted with the same plane in each state, as shown in FIGS. 5, 6 and 7.

As can be seen from FIGS. 1 to 3, the operation members 11 and the display device 12 are provided on an upper face of a protruded portion 24 of the coupler unit 9, which is protruded forward from the grip 7. Since the profiles of the power unit 8 and the battery pack 6 are larger than the profile of the grip 7, when the power tool is toppled down, a part of the power unit 8 and a part of the battery pack 6 are simultaneously contacted with the same plane such the land surface or the floor face. Thus, the grip 7 is departed from the land surface or the floor face.

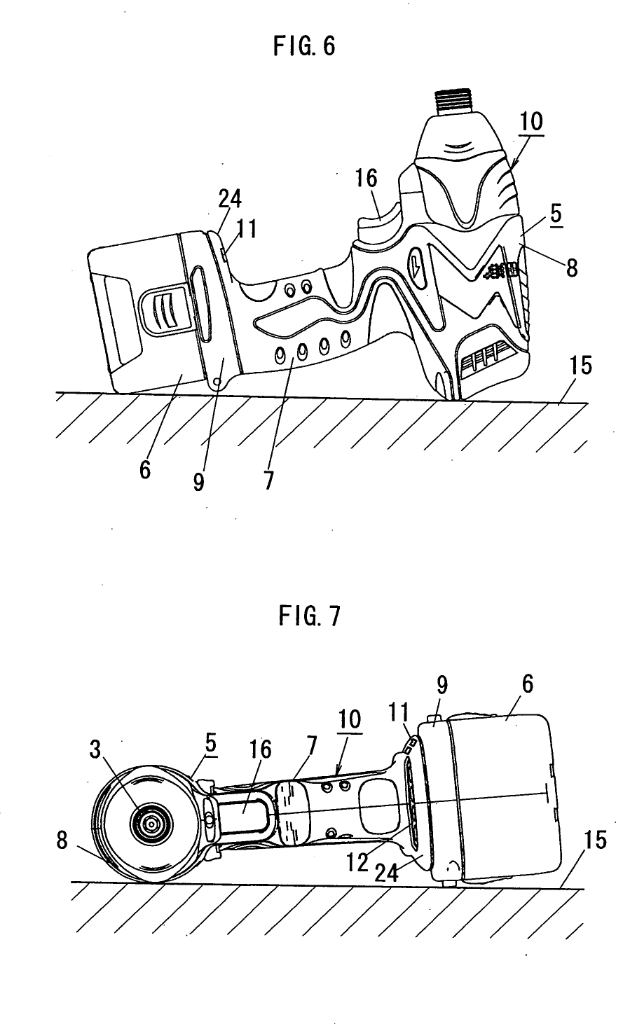

FIG. 5 shows an example of toppling down of the power tool 10 forward. In the case shown in FIG. 5, a lower front edge of the output shaft 3 which is included in the power unit 8 and a lower front edge of the battery pack 6 are contacted with the land surface or the floor face. FIG. 6 shows another example of toppling down of the power tool 10 backward. In the case shown in FIG. 6, the most protruded rear edge, for example, a lower rear edge of the power unit 8 and a lower rear edge of the battery pack 6 are contacted with the land surface or the floor face. FIG. 7 shows still another example of toppling down of the power tool 10 sideway. In the case shown in FIG. 7, the most protruded side portion or line of the power unit 8 and the most protruded side portion or line of the battery pack 6 are contacted with the land surface or the floor face. In each case, the upper face of the protruded portion 24 of the coupler unit 9, on which the operation members 11 and the display device 12 are provided, is departed from the land surface or the floor face. In other words, the operation members 11 and the display device 12 are provided at a positions near to the grip 7 from a line binding contacting portions of the power unit 8 and the battery pack 6 when the power unit 8 and the battery pack 6 are simultaneously contacted with the same plane in each state. By such a configuration, the operation members 11 and the display device 12 may not be damaged due to bumping against the land surface or the floor face even when the power tool 10 is fallen or toppled down on the land surface or the floor face.

A block configuration of the control unit of the power tool 10 is shown in FIG. 4. The control circuit 14 has a torque setting switch 11A, an over-fastening switch 11B, a main processor 13, an impact sensor 17, a torque calculator 18 and a rotation sensor 19. The main processor 13, the impact sensor 17 and the torque calculator 18 are constituted by, for example, a CPU (central processing unit), a ROM (read only memory) and a RAM (random access memory) and so on, which are commonly used. The rotation sensor 19 is, for example, an encoder provided on the driving shaft of the motor 1 for sensing the rotation speed and the rotation direction of the driving shaft of the motor 1. As shown in FIG. 3, the torque setting switch 11A and the over-fastening switch 11B are mounted at positions facing the operation members 11 (11a and 11b) on a printed circuit board of the control circuit 14.

When the user operates (for example, pushes) the operation members 11 (11a and 11b), the torque setting switch 11A and the over-fastening switch 11B are switched on. The main processor 13 counts numbers of switching on of the torque setting switch 11A and the over-fastening switch 11B. The main processor 13 selects a torque for fastening a fastening member such as a bolt, a nut or a screwnail, and so on, corresponding to the number of switching on of the torque setting switch 11A. The main processor 13 switches on and off the over-fastening mode corresponding to the number of switching on of the over-fastening switch 11B.

The switching circuit 4 has a main switch 20 operated by the trigger lever 16, a switching element 21 and the normal/reverse rotation switch 22A operated by the rotation switch lever 22. In FIG. 4, a numerical reference 23 designates a rechargeable secondary battery contained in the battery pack 6.

The example shown in FIG. 4 is a control circuit of an impact power tool such as an impact driver, since it has the impact sensor 17. When the over-fastening mode is switched on, the impact sensor 17 senses an impact of a hammer on an anvil fixed on the output shaft 3 of the power tool 10 corresponding to, for example, a variation of the rotation speed of the motor 1 sensed by the rotation sensor 19. The torque calculator 18 calculates a torque for fastening the fastening member with using, for example, the rotation angle of the driving shaft of the motor 1 and the reduction ratio of the reducer/transmitter 2 in an impact of the hammer on the anvil, or the like. The main processor 13 controls the driving of the motor 1 (starting and stopping the rotation of the driving shaft of the motor) via the switching circuit 4 with using the calculated torque or the like corresponding to the driving mode set by the user with using the operation members 11.

The switching on or off of the over-fastening mode, the selected operation mode, the remained capacity of the battery, or the like is displayed on the display device 12. The display device 12 is, for example, an LCD (liquid crystal display) device, which is directly mounted on the printed circuit board of the control circuit 14. It is possible to use an LED illumination device for illuminating the display on the display device 12 from the back face thereof.

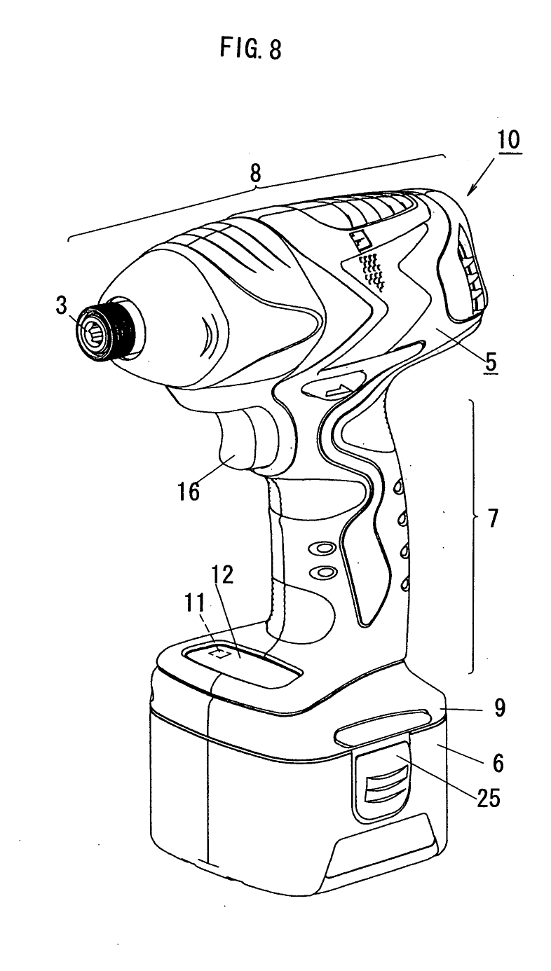

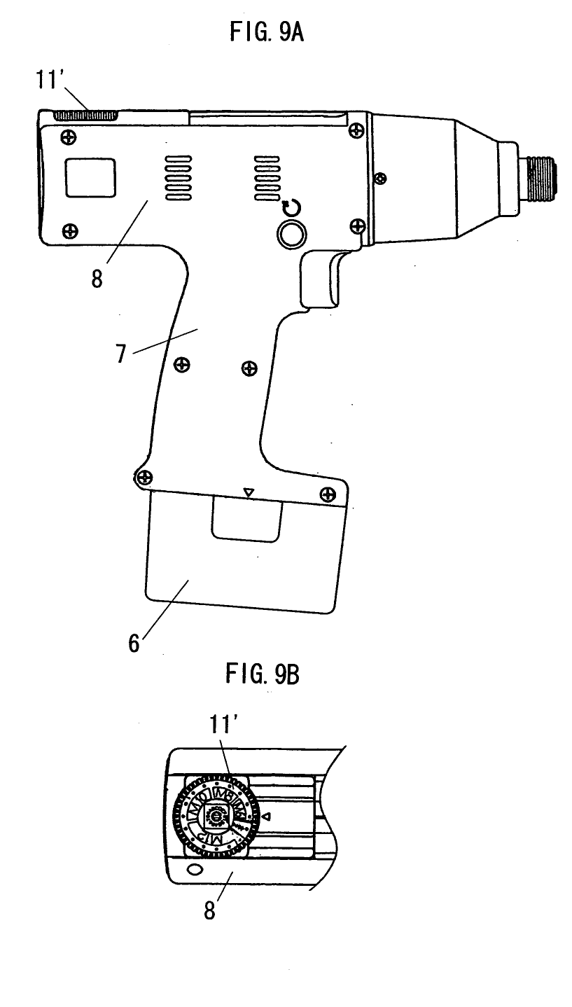

A modification of the power tool 10 in accordance with this embodiment is shown in FIG. 8. In this modification, an LCD device with a touch panel serving as operation members 11 is used as the display device 12. By such a modification, substantially the same effect as the above-mentioned embodiment can be obtained.

In the above-mentioned description, the display device 12 is provided on the protruded portion 24 of the coupler unit 9. It, however, is not necessary to provide the display device. In the present invention, at least an operation member used for selecting an operation mode of the motor is provided at a position near to the grip from a line binding contacting portions of the power unit and the battery pack when the power unit and the battery pack are simultaneously contacted with the same plane in each state. Furthermore, the position of the operation member or the display device is not limited to the above-mentioned description and the illustration in the drawings. Still furthermore, it is possible to use a plurality of LEDs and indications provided in the vicinity of respective LEDs as the display device instead of the LCD.

According to the present invention, the operation member may not be damaged due to bumping against the land surface or the floor face even when the power tool is fallen or toppled down on the land surface or the floor face. Consequently, the transportable power tool can be used stable over the long term. Furthermore, it is no need to reinforce the mechanical strength of the operation member and so on, so as not to be damaged due to the bumping. Thus, it is possible to reduce the cost of the transportable power tool.

This application is based on Japanese patent application 2003-381458 filed Nov. 11, 2003 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A transportable power tool comprising: a motor; a reducer-transmitter for reducing rotation speed of a driving shaft of the motor and for transmitting a driving force of the motor to an output shaft thereof; a control circuit for controlling driving of the motor; a housing for enclosing the motor, the reducer-transmitter and the control circuit; and a battery pack detachably coupled with the housing; wherein
the transportable power tool has a power unit in which at least the motor and the reducer-transmitter are contained, a grip and a coupler unit formed at an end of the grip opposite to the power unit with which the battery pack is coupled;
a center axis of the output shaft crosses a center axis of the grip around which a perm and fingers of a user grip at a predetermined angle near to right angle;
maximum dimensions of the power unit and maximum dimensions of the battery pack in a direction perpendicular to both of the center axis of the output shaft and the center axis of the grip and in a direction parallel to the center axis of the output shaft are larger than those of the grip in the same directions; and
at least an operation member used for selecting an operation mode of the motor is provided at a position near to the grip from a line binding contacting portions of the power unit and the battery pack when the power unit and the battery pack are simultaneously contacted with the same plane in each state.

2. The transportable power tool in accordance with claim 1, wherein
the operation member is provided on a surface of the coupler unit of the housing.

3. The transportable power tool in accordance with claim 1, wherein
the operation member is provided at a position except an outer surface of the grip.

4. The transportable power tool in accordance with claim 1, wherein
the operation member is a button movably held on the housing.

5. The transportable power tool in accordance with claim 1 further comprising:
a display device provided at a position near to the grip from a line binding contacting portions of the power unit and the battery pack when the power unit and the battery pack are simultaneously contacted with the same plane in each state.

6. The transportable power tool in accordance with claim 5, wherein
the display device is a liquid crystal display device.

7. The transportable power tool in accordance with claim 6, wherein
the display device has a touch panel serving as the operation member.

8. The transportable power tool in accordance with claim 5, wherein
the display device is provided on a surface of the coupler unit of the housing.

9. The transportable power tool in accordance with claim 5, wherein
the operation member and the display device are provided on a surface of a portion of the coupler unit of the housing protruding forward from the grip.

10. A transportable power tool comprising:
a power unit containing at least a motor and a reducer-transmitter for reducing rotation speed of a driving shaft of the motor and for transmitting a driving force of the motor to an output shaft thereof;
a grip formed in a manner so that a center axis of the output shaft crosses a center axis of the grip around which a perm and fingers of a user grip at a predetermined angle near to right angle;
a coupler unit formed at an end of the grip opposite to the power unit, with which a battery pack is coupled; and
a control circuit for controlling driving of the motor;
wherein
maximum dimensions of the power unit and maximum dimensions of the battery pack in a direction perpendicular to both of the center axis of the output shaft and the center axis of the grip and in a direction parallel to the center axis of the output shaft are larger than those of the grip in the same directions; and
at least an operation member used for selecting an operation mode of the motor is provided at a position near to the grip from a line binding contacting portions of the power unit and the battery pack when the power unit and the battery pack are simultaneously contacted with the same plane in each state.
